(19) United States
(12) Patent Application Publication
(10) Pub. No.: US 2024/0123656 A1
(43) Pub. Date: Apr. 18, 2024

(54) APPARATUS AND METHOD FOR FILLING A MOULD

(71) Applicant: SACMI COOPERATIVA MECCANICI IMOLA SOCIETA' COOPERATIVA, IMOLA (BOLOGNA) (IT)

(72) Inventors: FABRIZIO PUCCI, CASTEL GUELFO DI BOLOGNA (IT); FIORENZO PARRINELLO, MEDICINA (IT); GIOVANNI MAZZOTTI, RAVENNA (IT); FRANCESCO PIRAZZOLI, IMOLA (IT); DAVIDE ZANOTTI, IMOLA (IT)

(21) Appl. No.: 18/263,290

(22) PCT Filed: Feb. 1, 2022
(86) PCT No.: PCT/IB2022/050848

§ 371 Date: Jul. 27, 2023

(30) Foreign Application Priority Data
Feb. 4, 2021 (IT) 102021000002525

(51) Int. Cl. B29C 33/00; B29C 31/04; B29C 33/10

(52) U.S. Cl. CPC B29C 33/0072; B29C 31/04; B29C 33/10; B29K 2001/00

(57) ABSTRACT

An apparatus comprises a mould part having a forming chamber and a filling device for filling the forming chamber with a mouldable material. The filling device comprises an entry duct for a flow of mouldable material and air and a preliminary chamber communicating with the forming chamber. The entry duct opens into the preliminary chamber in a position such as to send the flow of mouldable material and air towards the forming chamber with a helicoidal movement, so as to separate the mouldable material from the air.

The invention relates to an apparatus and a method for filling a mould with a mouldable material.

The mouldable material can comprise a material derived from natural fibres, for example cellulose, to which a synthetic polymeric material or other additives of various types can optionally be added.

In particular, the material derived from natural fibres can be in the form of powder, granules or flakes. These various forms of material can have different degrees of agglomeration, that is to say, be more or less agglomerated, depending on the features of the material derived from natural fibres and/or the amount of moisture/water or of any other additives present in the natural fibre-based material.

Also other mouldable materials, not derived from natural fibres, can be in these forms and be processed with the apparatus and the method according to the invention.

The apparatus and the method according to the invention are particularly (but not exclusively) suitable for filling moulds intended to make objects having a concave shape, for example containers or caps for containers. Often, the mouldable materials derived from natural fibres, for example the cellulose-based materials, have a very low initial density and need to be pressed with a high degree of compaction to obtain a good quality object. That means that, when a mould is filled with a material derived from natural fibres, it is necessary to fill an initial volume which is relatively large if compared with the final volume of the moulded object.

This operation is not easy, also because sometimes it is difficult for the natural fibre-based mouldable materials to flow inside the mould and they can accumulate in a non-homogeneous way in some regions of the mould, leaving other regions of the mould almost empty.

Therefore it is difficult to fill the mould in a uniform way, which is an important requirement for obtaining a good quality moulded object.

Moreover, when a material derived from natural fibres is introduced into the mould, incorporated inside the material derived from natural fibres there can be a considerable amount of air, which has to be eliminated from the mould before obtaining the final object. It is desirable to remove from the mould the largest possible amount of air during filling, so as to reduce the amount of air which must be discharged during the moulding.

An object of the invention is to improve the apparatuses and the methods for filling a mould with a mouldable material, particularly containing a material derived from natural fibres, for example cellulose.

A further object is to provide an apparatus and a method for filling a mould with a mouldable material, for example containing a material derived from natural fibres, which allow the mould to be filled in a unform way.

Another object is to provide an apparatus and a method for filling a mould with a mouldable material, for example containing a material derived from natural fibres, which have reduced construction difficulties and have simple operation.

Another object is to provide an apparatus and a method for filling a mould with a mouldable material, for example containing a material derived from natural fibres, which make it possible to discharge air from the mould during the filling.

In a first aspect of the invention, an apparatus is provided comprising a mould part having a forming chamber and a filling device for filling the forming chamber with a mouldable material, the filling device comprising an entry duct for a flow of mouldable material and air and a preliminary chamber communicating with the forming chamber, wherein the entry duct opens into the preliminary chamber in a position such as to send the flow of mouldable material and air towards the forming chamber with a helicoidal movement, so as to separate the mouldable material from the air.

In a second aspect of the invention, a method is provided for filling a forming chamber of mould with a mouldable material, comprising the step of sending a flow of mouldable material and air into a preliminary chamber communicating with the forming chamber, wherein the flow of mouldable material and air moves in the preliminary chamber with a helicoidal movement to separate the mouldable material from the air, and wherein the mouldable material separated from the air accumulates in the forming chamber.

Owing to the first and to the second aspect of the invention, and in particular owing to the helicoidal movement of the flow of mouldable material and air in the preliminary chamber, a cyclone separator is defined in the preliminary chamber. That allows the air to be effectively separated from the mouldable material, so that the amount of air which enters the forming chamber is much less than the amount of air which was present in the flow entering the preliminary chamber.

More specifically, during the helicoidal movement inside the preliminary chamber, the particles of mouldable material strike a surface which delimits the preliminary chamber, which helps the particles of mouldable material to separate from the air. The particles than accumulate in the forming chamber, which can be below or above the preliminary chamber.

At the outfeed of the preliminary chamber, the mouldable material—which contains a much smaller amount of air or does not contain any air at all—can be uniformly compressed for relatively easily creating a desired object.

In other words, the mouldable material arriving from the preliminary chamber, which enters the forming chamber, has already undergone a sort of “pre-compaction”, in the sense that it has already lost a significant amount of the air which it initially contained. This means that it is faster and easier to achieve the desired degree of compaction, when compressing the mouldable material in the forming chamber.

The apparatus according to the first aspect of the invention and the method provided by the second aspect of the invention also allow the forming chamber to be filled with the mouldable material in a simple way, because they do not require moving mechanical components for separating the air from the mouldable material.

In a third aspect of the invention, a mould is provided for forming an object with a mouldable material, comprising a case, an inner forming element at least partly housed in the case, an intermediate element which surrounds the inner forming element, wherein between the inner forming element and the case a hollow space can be defined, the intermediate element being positionable in the hollow space in a back position, in which the mouldable material is received in the hollow space, the intermediate element being slidable relative to the inner forming element from the back position towards a forming position, so as to reduce the volume of the hollow space and to form a lateral wall of the object.

In a fourth aspect of the invention, a method is provided for forming an object with a mouldable material, comprising the steps of:
introducing the mouldable material into a case, an inner forming element being at least partly housed in the case, the inner forming element being surrounded by an intermediate element;
moving the intermediate element backwards relative to the inner forming element, thereby causing the mouldable material to flow in a hollow space defined between the inner forming element and the case;
moving the intermediate element forward relative to the inner forming element, in order to reduce the volume of the hollow space and to form a lateral wall of the object.

By moving the intermediate element backwards relative to the inner forming element, that is to say, positioning the intermediate element in the back position, it is possible to create in the hollow space a sort of negative pressure which attracts the mouldable material into the hollow space. That allows the hollow space to be effectively filled, even if the latter has a considerable axial dimension, or a relatively small radial thickness, and even if the mouldable material does not easily flow in the mould. In this way it is possible to obtain objects in which the mouldable material has been compacted in a substantially uniform way in practically all of the portions of the object.

The mould according to the third aspect of the invention and the method according to the fourth aspect of the invention do not require complex construction, since they can operate using only forward and backward movements, that is to say, in an axial direction, of the components of the mould which are involved. That is to say, there is no need for transversal or radial movements, which could complicate the structure of the mould and its operation.

In one embodiment, the inner forming element is a male forming element. The male forming element can delimit a portion of a forming chamber arranged inside the case.

The intermediate element can be a tubular element which surrounds the male forming element.

The hollow space can be an annular space defined between the male forming element and the case.

In a fifth aspect of the invention, a mould is provided for forming an object with a mouldable material, comprising a forming chamber having a lateral portion which at least partly surrounds an axis, the mould further comprising a filling device having a peripheral duct which at least partly surrounds the axis and is selectively openable for feeding the mouldable material into the lateral portion.

In a sixth aspect of the invention, a method is provided for forming an object with a mouldable material in a forming chamber having a lateral portion which at least partly surrounds an axis, the method comprising the step of selectively opening a peripheral duct which at least partly surrounds the axis for feeding the mouldable material into the lateral portion.

Owing to the fifth and to the sixth aspect of the invention, it is possible to fill the forming chamber with a substantially uniform degree of compaction, so as to obtain good quality objects, particularly but not exclusively concave objects such as caps, containers, or preforms for containers.

In one embodiment, the lateral portion of the forming chamber is a tubular portion which surrounds the axis.

In one embodiment, the forming chamber has a transversal portion which closes the tubular portion transversally to the axis.

The filling device can comprise a central duct selectively openable for feeding the mouldable material into the transversal portion.

The invention can be better understood and implemented with reference to the accompanying drawings, which illustrate several example, non-limiting embodiments of it, in which:

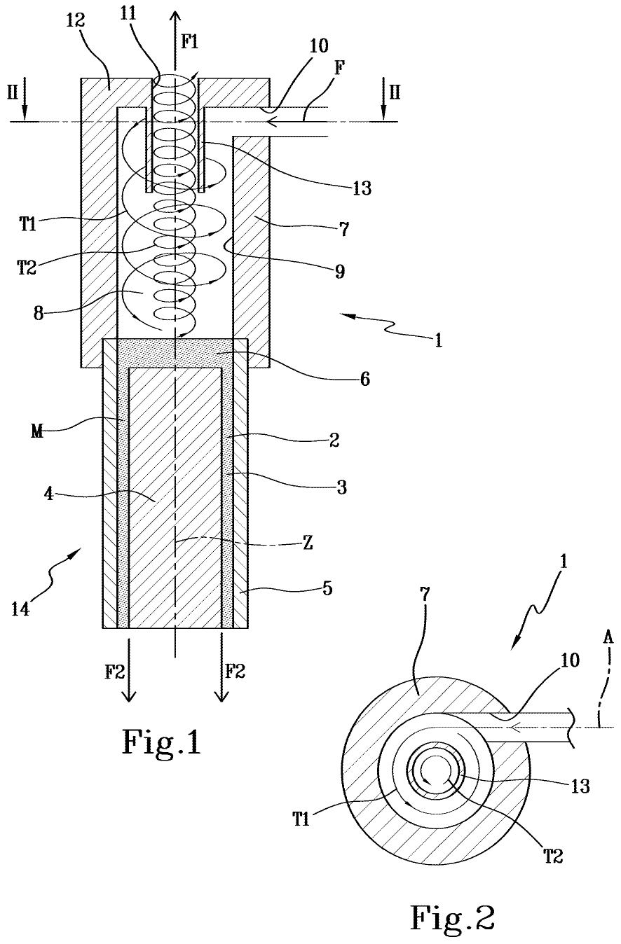

FIG. 1 is a schematic cross-section view of an apparatus for forming an object with a mouldable material;

FIG. 2 is a cross-section taken along the plane II-II of FIG. 1;

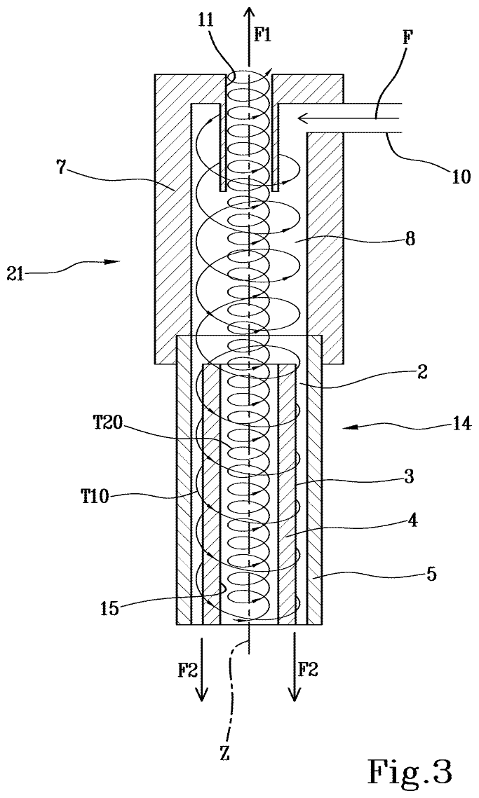

FIGS. 3 to 5 are schematic cross-section views like that of FIG. 1, each of which shows an apparatus for forming an object with a mouldable material according to a respective alternative embodiment;

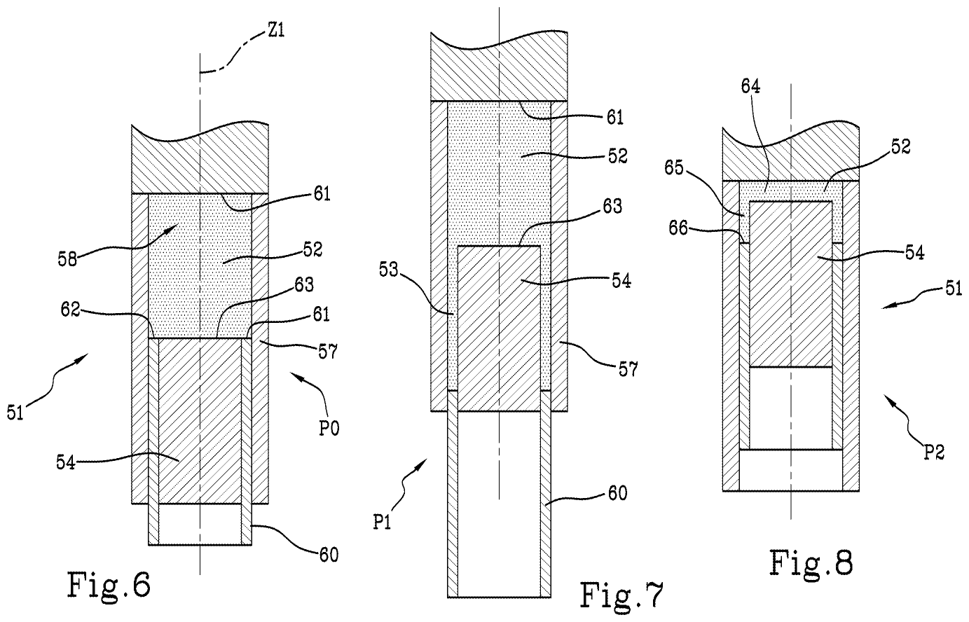

FIG. 6 is a schematic cross-section view of a mould for forming an object, in an initial configuration;

FIG. 7 is a view like that of FIG. 6, showing the mould in an intermediate configuration;

FIG. 8 is a view like that of FIG. 6, showing the mould in a final forming configuration;

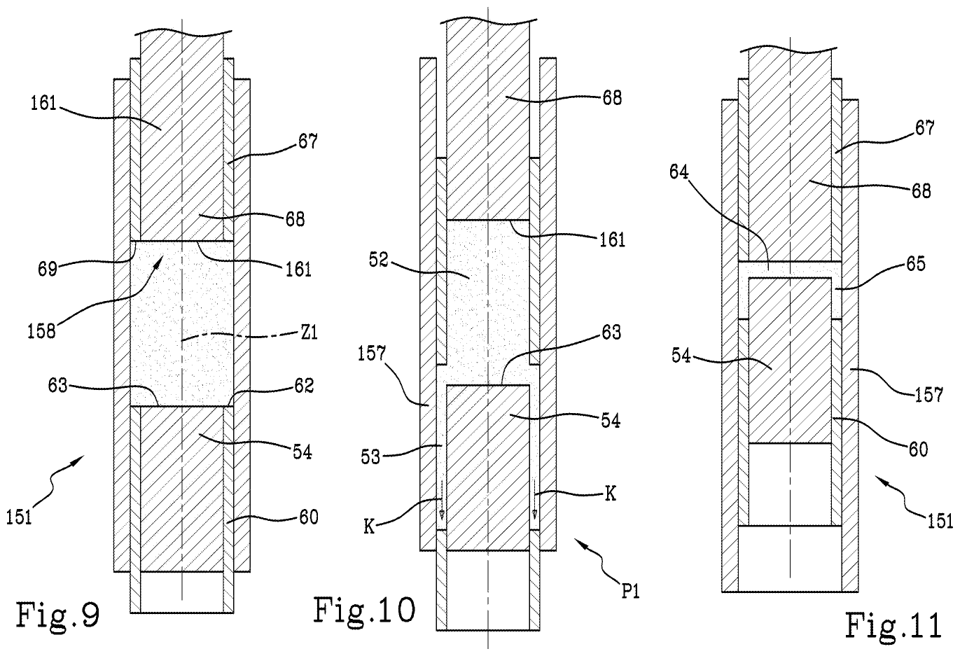

FIG. 9 is a schematic cross-section view of an alternative embodiment of a mould for forming an object, in an initial configuration;

FIG. 10 is a view like that of FIG. 9, showing the mould in an intermediate configuration;

FIG. 11 is a view like that of FIG. 9, showing the mould in a final forming configuration;

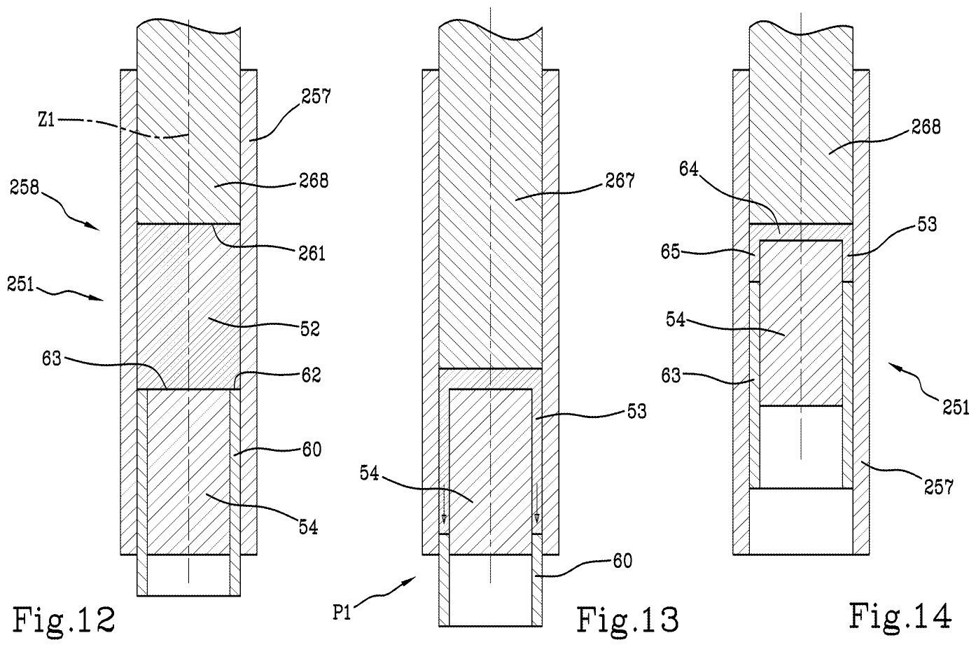

FIG. 12 is a schematic cross-section view of another alternative embodiment of a mould for forming an object, in an initial configuration;

FIG. 13 is a view like that of FIG. 12, showing the mould in an intermediate configuration;

FIG. 14 is a view like that of FIG. 12, showing the mould in a final forming configuration;

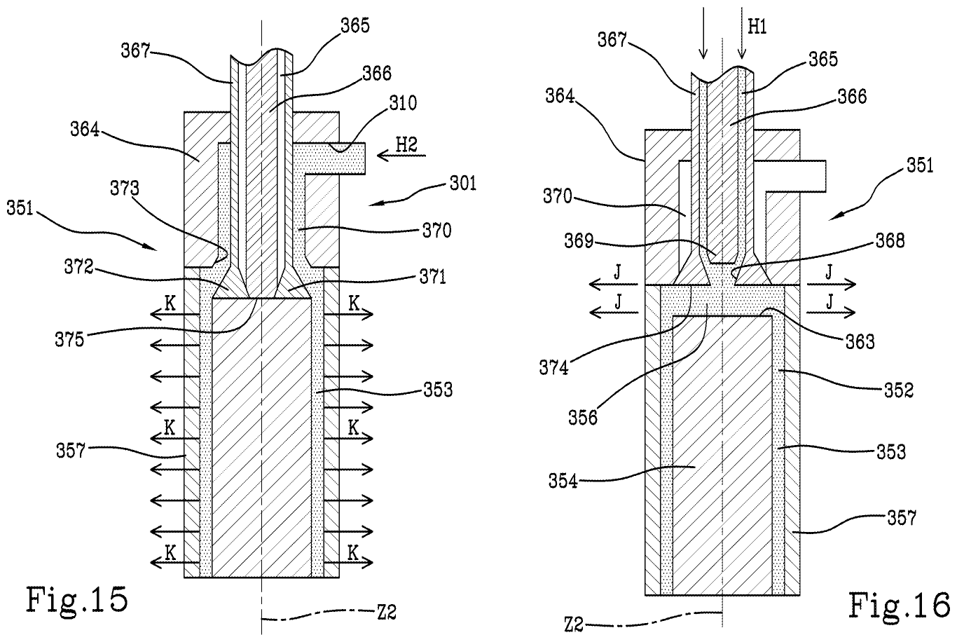

FIG. 15 is a schematic cross-section view of a mould for forming an object, during a step of filling a lateral portion of a forming chamber of the mould;

FIG. 16 is a schematic cross-section view of the mould of FIG. 15, during a step of filling a transversal portion of the forming chamber;

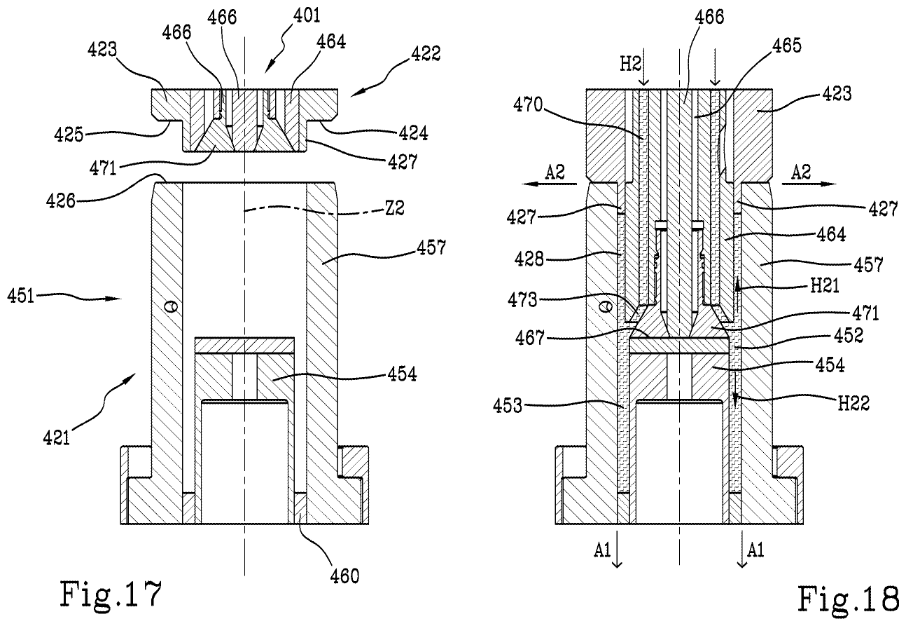

FIG. 17 is a schematic cross-section view, showing a mould according to an alternative embodiment, in a spaced apart configuration in which a first forming element and a second forming element are spaced apart;

FIG. 18 is a view like that of FIG. 17, during a step of filling a lateral portion of a forming chamber of the mould;

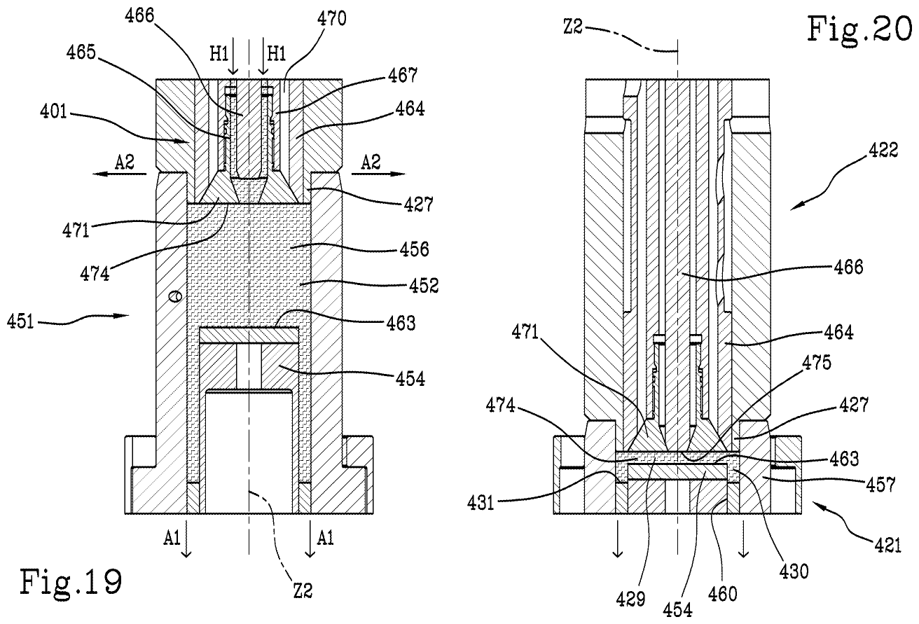

FIG. 19 is a view like that of FIG. 17, during a step of filling a transversal portion of the mould;

FIG. 20 is a view like that of FIG. 17, during a forming step.

FIGS. 1 and 2 show a device 1 for filling a forming chamber of a mould with a mouldable material, for example but not exclusively a mouldable material containing a material derived from natural fibres, especially cellulose. The mouldable material can be in the form of powder, granules or flakes. The mouldable material can optionally comprise additives such as adhesive substances.

The device 1 allows the mouldable material to be introduced into a forming chamber 2, schematically illustrated in FIG. 1, of a mould in which the mouldable material can be shaped so as to obtain a desired object. In the example shown, the forming chamber 2 is configured to form an object having a concave shape, for example a container, a cap for a container, a preform for a container or the like.

The mould in which the forming chamber 2 is defined can be included in a compression moulding apparatus for obtaining the desired object by compression moulding.

The forming chamber 2 can in particular comprise a tubular portion or lateral portion 3, which extends around an axis Z, intended to form a lateral wall of the object. The lateral portion 3 can have a cross-section, taken in a plane perpendicular to the axis Z, delimited by an outer perimeter which is circular, or elliptical, or polygonal with an arbitrary number of sides, or other. The lateral portion 3 can extend around the axis Z for 360°, in which case the lateral portion 3 has a cross-section (that is to say, a section taken in a plane perpendicular to the axis Z) which is closed around the axis Z. Alternatively, the lateral portion 3 can extend for less than 360° around the axis Z, in which case the lateral portion 3 has a cross-section (that is to say, a section taken in a plane perpendicular to the axis Z) which is open, for example in the shape of a “C” or the shape of a “U”.

The forming chamber 2 is defined in a mould part 14 suitable for operating in conjunction with a further mould part not shown for forming the object. The mould part 14 comprises an inner forming element 4, which delimits the lateral portion 3 from the inside of the latter, and an outer forming component 5, which surrounds the lateral portion 3, that is to say, delimits it from the outside. The lateral portion 3 is therefore defined between the inner forming element 4 and the outer forming component 5. The inner forming element 4 can be a male forming element.

The mould part 14 further comprises an intermediate forming element not shown, which is slidable inside the lateral portion 3 for forming an edge zone of the object. In the example shown, the intermediate forming element is an annular forming element, intended to form an annular edge zone of the object.

The intermediate forming element is positioned on the opposite side to the filling device 1, that is to say, at a lower end of the forming chamber 2 shown in FIG. 1. The intermediate forming element therefore closes the forming chamber 2 on the opposite side to that into which the mouldable material is introduced.

In more detail, the lateral portion 3 has a dimension, along the axis Z, greater than the dimension along the axis Z of the object to be obtained. That happens because the mouldable material which fills the lateral portion 3 of the forming chamber 2 is intended to be compressed in an axial direction, owing to the above-mentioned intermediate forming element, which slides between the inner forming element 4 and the outer forming component 5, after the forming chamber 2 has been filled. In this way, the dimensions of the lateral wall of the object in a direction parallel to the axis Z are reduced during forming.

The forming chamber 2 can further comprise an end portion 6, intended to create a transversal wall of the object, that is to say, a wall which, when the object has been formed and is still in the forming chamber 2, extends transversally, in particular perpendicularly, to the axis Z.

In the example shown, the end portion 6 of the forming chamber 2 is positioned above the lateral portion 3, in such a way that the object which is formed is a concave object in an upside down position, that is to say, with a concavity facing downwards. However, this condition is not necessary, and other arrangements of the object to be formed are possible. For example, the lateral portion 3 could be positioned above the end portion 6, so as to form a concave object with a concavity facing upwards.

The filling device 1 is located above the mould part 14, for filling the forming chamber 2 with the mouldable material which flows from the top downwards. This condition is not necessary, and the filling device 1, in an alternative embodiment not shown, could also be positioned in a different way relative to the forming chamber 2, for example below the mould part 14.

The filling device 1 comprises an outer case 7 inside which a preliminary chamber 8 is defined, the preliminary chamber 8 being suitable for receiving the mouldable material before the latter arrives in the forming chamber 2. The outer case 7 is delimited by an inner surface 9 which, in a cross-section taken perpendicularly to the axis Z, has a perimeter corresponding to, or more specifically equal to, the outer perimeter of the cross-section of the lateral portion 3. This avoids discontinuities between the inner surface 9 of the outer case 7 and a surface which delimits from the inside the outer forming component 5.

In the example shown, the inner surface 9 has the shape of a cylinder with a circular base, but other shapes are also possible, for example a cylinder with an elliptical base, or a prism with a polygonal base, or other, depending on the shape of the object to be obtained.

The filling device 1 also has an entry duct 10 through which a flow F of mouldable material and air can enter the preliminary chamber 8. The entry duct 10 is positioned in such a way that the flow of mouldable material and air flows in the preliminary chamber 8 towards the forming chamber 2 with a helicoidal movement around the axis Z. For that purpose, the entry duct can open into the preliminary chamber 8 in a tangential direction, for example in such a way that a generatrix of the entry duct 10 (if the latter has a cylindrical shape) is tangent to the inner surface 9 of the preliminary chamber 8, as shown in the example of FIG. 2.

More generally, the entry duct 10 can extend, at least at an end portion thereof, along a longitudinal axis A not radial relative to the axis Z, that is to say, which does not intersect the axis Z.

It is also possible for the entry duct 10 to extend along a curved axis. In this case, a straight line tangent to the curved axis in an end section of the entry duct 10 does not intersect the axis Z.

In other words, the entry duct 10 is configured to send into the preliminary chamber 8 a flow F of mouldable material and air in a direction not radial relative to the axis Z, in such a way that the flow F strikes the inner surface 9 of the preliminary chamber 8 and is directed towards the forming chamber 2 along a helicoidal trajectory around the axis Z.

The entry duct 10 can open into the preliminary chamber 8 in a position near one end of the preliminary chamber 8, in particular in a position near the end of the preliminary chamber 8 opposite to the further end of the preliminary chamber 8 adjacent to the forming chamber 2.

In the example shown, the entry duct 10 opens into an upper region of the preliminary chamber 8, and the flow F of mouldable material and air moves from the top downwards to reach the forming chamber 2. In an alternative embodiment, the entry duct 10 can be located in a different position and the flow F of mouldable material and air can, for example, move from the bottom upwards.

The flow F intended to flow in the entry duct 10 can be a flow of mouldable material and compressed air, in which case the filling device 1 comprises a compressed air source not shown positioned upstream of the entry duct 10 for supplying compressed air intended to be mixed with the mouldable material. The compressed air pushes the mouldable material towards the preliminary chamber 8 and from the latter towards the forming chamber 2 and can be helpful in making the mouldable material flow along a helicoidal path inside the preliminary chamber 8.

In an alternative embodiment, the compressed air source can be absent. In this case, the flow F is a flow of mouldable material together with air, at ambient pressure, which is interposed between the particles of mouldable material before the mouldable material is compacted in the mould.

The main function of the air mixed with the particles of mouldable material in the flow F is to convey the particles inside the preliminary chamber 8.

By moving inside the preliminary chamber 8 with a helicoidal movement, the particles of mouldable material present in the flow F strike against the inner surface 9 and separate from the air which is initially present in the flow F. That allows the air to be separated from the mouldable material.

The filling device 1 further comprises an outfeed duct 11 for making the air separated from the mouldable material come out of the preliminary chamber 8. In the example shown, the outfeed duct 11 is axial, that is to say, extends along the axis Z of the preliminary chamber 8.

The outfeed duct 11 can be positioned in a region of the outer case 7 opposite to the forming chamber 2. In the example shown, the outfeed duct 11 opens into an upper region of the preliminary chamber 8, even if this condition is not necessary.

In the example shown, the outfeed duct 11 passes through an end wall 12 of the outer case 7, the end wall 12 being positioned transversally, in particular perpendicularly, to the axis Z.

The outfeed duct 11 is also defined inside a tubular projection 13 which from the end wall 12 projects inside the preliminary chamber 8, that is to say, towards the forming chamber 2.

The tubular projection 13 can be delimited by a cylindrical inner surface. The tubular projection 13 can have a dimension, along the axis Z, less than the dimension along the axis Z of the preliminary chamber 8.

During operation, the filling device 1 and the mould part 14 are initially in a filling position, shown in FIG. 1, in which the filling device 1 and the mould part 14 are aligned along the axis Z. In the embodiment shown, the filling device 1 is positioned above the mould part 14, in the filling position.

A flow F of mouldable material and air is sent into the preliminary chamber 8 through the entry duct 10. As previously described, the air mixed with the mouldable material can be at a pressure greater than the ambient pressure (compressed air) or at ambient pressure. The flow F moves inside the preliminary chamber 8 with a helicoidal movement, that is to say, following a helicoidal trajectory (indicated as T1 in FIGS. 1 and 2), around the axis Z. The helicoidal movement is a movement along a helix which, in the example shown, is a cylindrical helix. In one embodiment not shown, the helicoidal movement of the flow F could be along a conical helix. The helicoidal movement of the flow F occurs in a peripheral region of the preliminary chamber 8 which can be axially aligned with the lateral portion 3 of the forming chamber 2

While the flow F moves with a helicoidal movement, the particles of mouldable material strike against the inner surface 9 of the forming chamber 8 and separate from the air present in the flow F. The mouldable material separated from the air decelerates and accumulates at the end of the preliminary chamber 8 opposite to the entry duct 10, thereby filling the adjacent forming chamber 2.

In the example shown, the mouldable material, indicated with the letter M in FIG. 1, descends under gravity in the lateral portion 3 of the forming chamber 2, which is filled in a particularly effective way, even if the lateral portion 3 has dimensions which are considerable along the axis Z and/or relatively small in a radial direction.

The mouldable material also arrives in the end portion 6 of the forming chamber 2.

Since a significant amount of air separated from the mouldable material during the path of the flow F in the preliminary chamber 8, the mouldable material which accumulates in the forming chamber 2 has a much higher density than the mouldable material which flows through the entry duct 8. In this way it becomes easier to press the mouldable material during the subsequent step of compression moulding, because the amount of air which has to be expelled from the mouldable material during pressing is limited. In other words, owing to the separation of the air which occurs in the preliminary chamber 8, the mouldable material which enters the forming chamber 2 is so to speak “pre-compacted”, which makes the subsequent forming easier.

The filling device 1 therefore acts as a cyclone separator, which is associated with the mould to separate the air present in the flow F from the mouldable material, which subsequently fills the mould.

The air separated from the mouldable material comes out of the preliminary chamber 8 through the outfeed duct 11. More specifically, the air comes out of the preliminary chamber 8 with a helicoidal movement around the axis Z. As shown in FIGS. 1 and 2, the air follows in particular a trajectory T2 along a helix which is coaxial with the helix which defines the trajectory T1, but has a smaller radius than the helix which defines the trajectory T1. That means that the air coming out moves along the trajectory T2 which is inside the trajectory T1 of the flow of mouldable material and air coming in. Moreover, the movement of the air coming out occurs in a direction opposite to that of the flow F of mouldable material and air coming in, in the sense that, in the example shown, the air coming out goes from the bottom upwards, whilst the flow F of mouldable material and air coming in goes from the top downwards.

Suction means not shown can be associated with the outfeed duct 11, to suck out the air present in the preliminary chamber 8 and facilitate it coming out following the trajectory T2, as indicated by the arrow F1 of FIG. 1. Moreover, the mould part 14 in which the forming chamber 2 is included is provided with vent openings to allow the discharge of the air still present in the mouldable material during forming. The vent openings can be axial, as indicated by the arrows F2 of FIG. 1. Alternatively or in addition to the above, the vent openings can be radial.

The vent openings can be connected to a suction source so as to help the air come out of the mould. The suction source allows optimisation of filling of the forming chamber 2 by the mouldable material, especially if the forming chamber 2 is positioned above the preliminary chamber 8 and consequently it is not possible to exploit the force of gravity for filling the forming chamber 2.

After the forming chamber 2 has been filled with the mouldable material, a driving device not shown moves the filling device 1 and the mould part 14 one relative to the other, so that the filling device 1 and the mould part 14 are no longer aligned with each other along the axis Z. In other words, the driving device is configured to disengage the filling device 1 from the forming chamber 2. In this way the mould part 14 can engage with a further mould part not shown, arranged to close the forming chamber 2 at the end portion 6, transversally to the axis Z.

The step of compression moulding can now begin, in which the mould part 14 which includes the forming chamber 2 and the further mould part not shown move one towards the other to compact the mouldable material and to form the object.

The intermediate forming element not shown, associated with the lateral portion 3 of the forming chamber 2, slides inside the lateral portion 3 towards the end portion 6, for forming an edge zone of the object which extends transversally to the axis Z, on the opposite side to the end portion 6. After the object has been formed in the mould, the latter can be opened and the mould part 14 can engage with the filling device 1 so that it can be filled again.

In an alternative embodiment not shown, the outfeed duct 11 can be made in the inner forming element 4, rather than in the end wall 12 of the outer case 7. The outfeed duct 11 can extend in particular in a central zone of the inner forming element 4, for example along the axis Z. In this case, the air separated from the mouldable material comes out of the preliminary chamber 8 by passing through the inner forming element 4 with a helicoidal movement. The air coming out moves along a helicoidal trajectory defined by a helix having a smaller radius than the helix which defines the trajectory T1 of the flow F of mouldable material and air coming in. In this case the air coming in moves in the same direction as the flow F, that is to say, from the top downwards in the example shown. Suction means can be associated with the outfeed duct to suck out the air separated from the mouldable material and to help the air come out of the mould part 14. This alternative embodiment can be helpful for more effectively filling the end portion 6 of the forming chamber 2.

In the embodiment described with reference to FIGS. 1 and 2, the helicoidal movement of the flow of mouldable material and air mainly occurs in the preliminary chamber 8 and substantially ends near the end portion 6. FIG. 3 shows a filling device 21 according to an alternative embodiment, which differs from the embodiment of FIGS. 1 and 2 because the helicoidal movement of the flow F of mouldable material and air occurs not just in the preliminary chamber 8, but also continues in the lateral portion 3 of the forming chamber 2. That is to say, the flow F of mouldable material and air which enters from the entry duct 10 moves along a helicoidal trajectory T10 which, from the region of the preliminary chamber 8 into which the entry duct 10 opens, passes into the end of the preliminary chamber 8 adjacent to the forming chamber 2 and from here continues into the lateral portion 3 defined between the inner forming element 4 and the outer forming component 5. That allows the mouldable material to be accompanied into the lateral portion 3, helping the mouldable material to fill the lateral portion 3 even if the lateral portion 3 has considerable axial dimensions and/or the mouldable material does not flow easily and tends to easily become packed. The helicoidal trajectory T10 can extend as far as the end of the lateral portion 3 opposite to the preliminary chamber 8. The air separated from the mouldable material returns into the outside environment by following a helicoidal trajectory T20 which extends in a transit duct 15 made in the inner forming element 4. In the example shown, the latter has a tubular shape, so that the transit duct 15 extends from one end to the other of the inner forming element 4. From the inner forming element 4, the air then flows into the preliminary chamber 8 until it reaches the outfeed duct 11, similar to that shown in FIG. 1. From the outfeed duct 11, the air is finally discharged into the outside environment, as indicated by the arrow F1.

The helicoidal trajectory T20 along which the flow of air coming out moves has a smaller radius than the helicoidal trajectory T10 followed by the flow F of mouldable material and air and is positioned inside the helicoidal trajectory T10. The helicoidal trajectory T20 extends in a central region, along the axis Z, of the mould part 14 and of the filling device 21. To make the helicoidal trajectory T10 continue in the lateral portion 3, it is possible to act on the geometric and dimensional features and position of the entry duct 10, as well as on the properties of the flow F of mouldable material and air coming in (pressure, flow rate, etc.) and if necessary to provide a suction source at the end of the lateral portion 3 opposite to the filling device 21.

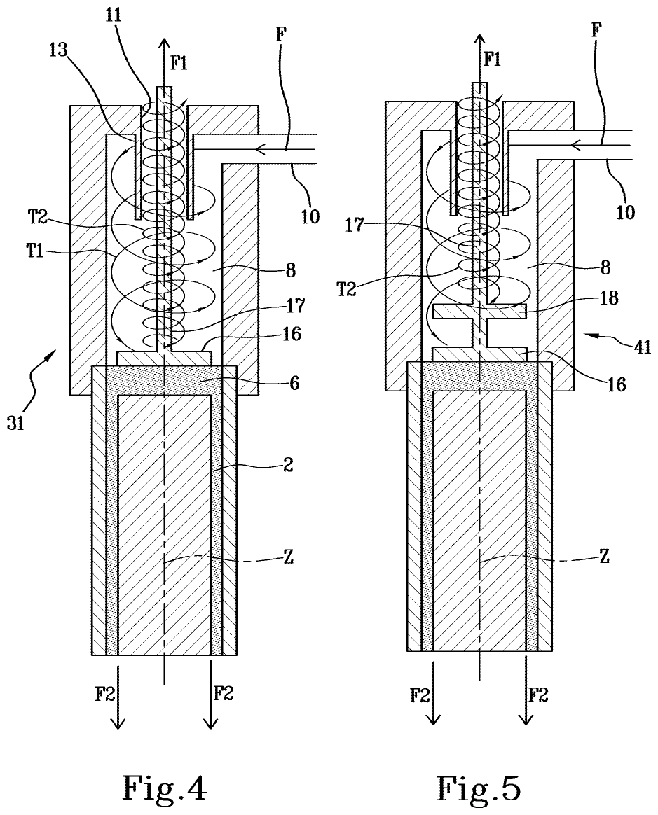

FIG. 4 shows a filling device 31 according to an alternative embodiment, which differs from the embodiment shown in FIGS. 1 and 2 because the filling device 31 comprises a distribution plate 16 to allow an improved distribution of the mouldable material in the end portion 6 of the forming chamber 2.

The distribution plate 16, which for example can have a circular shape in plan view, is fixed to one end of a rod 17 positioned along the axis Z. The distribution plate 16 mainly extends in a plane perpendicular to the axis Z.

The rod 17 can extend up to an end of the preliminary chamber 8 opposite to the forming chamber 2, passing through the outfeed duct 11.

In the filling device 31, the flow of air, which separated from the mouldable material and is heading towards the outfeed duct 11, starts above the distribution plate 16. The mouldable material interposed between the distribution plate 16 and the male forming element 2 is not disturbed by the flow of air coming out and can better fill the end portion 6.

The air coming out goes towards the outside environment again in this case by following a helicoidal trajectory T2, which extends around the axis Z, inside the helicoidal trajectory T1 followed by the flow F of mouldable material and air. In the example shown, the trajectory T2 is interposed between the rod 17 and the tubular projection 13, in the region in which the latter is provided.

FIG. 5 shows a filling device 41 according to another alternative embodiment, which differs from the embodiment shown in FIG. 4 because, in addition to the distribution plate 16, a further distribution plate 18 is provided. The distribution plate 16 is interposed between the forming chamber 2 and the further distribution plate 18. Both the distribution plate 16 and the further distribution plate 18 are fixed relative to the rod 17. Also the further distribution plate 18 can have a circular shape in plan view and extend in a plane arranged transversally, in particular perpendicularly, to the axis Z. The distribution plate 16 and the further distribution plate 18 are parallel to each other.

The flow of air which comes out of the preliminary chamber 8 after having been separated from the mouldable material starts immediately above the further distribution plate 18, with a helicoidal movement along the trajectory T2. This improves the filling of the end portion 6 by the mouldable material. In one embodiment not shown, the plate 16, and/or the further plate 18, and/or the rod 17 can be perforated.

It is also possible to provide a number of distribution plates greater than two. What was previously mentioned with reference to FIGS. 1 and 2 regarding the alternative embodiments also applies to the embodiments of FIGS. 3 to 5. In particular, in all of the examples shown the mould part 14 can be positioned above the filling device.

The outfeed duct 11 can pass through the inner forming element 4, rather than opening onto the wall of the outer case 7 opposite to the mould part 14.

In the first mould part 14 there can be axial and/or radial vent ducts for making the air still mixed with the mouldable material come out, the vent ducts being optionally provided with suction means. A suction source can also be associated with the outfeed duct 11.

FIGS. 6 to 8 show a mould 51 for forming an object from a mouldable material, particularly a material containing a material derived from natural fibres, such as cellulose. The mould 51 is particularly suitable for processing a mouldable material in the form of powder, granules or flakes. The mould 51 can be for example used for forming a concave object such as a cap, a container, a preform for a container. More generally, as shown in FIG. 8, the object formed in the mould 51 can comprise a lateral wall 65 which extends around an axis which, in FIGS. 6 to 8, has been indicated as Z1, and a transversal wall 64 which extends transversally, for example perpendicularly, to the above-mentioned axis. The lateral wall 65 can have various shapes, for example cylindrical, frustoconical, prismatic with a cross-section which is polygonal or elliptical, or other. The transversal wall 64 can be flat or have other shapes.

The mould 51 can be included in a compression moulding apparatus.

The mould 51 comprises an inner forming element 54 suitable for shaping the object from the inside. The inner forming element 54 can be a male forming element.

An intermediate element 60 surrounds the inner forming element 54. The intermediate element 60 can be shaped like a tubular element.

The intermediate element 60 can be in direct contact with the inner forming element 54, as shown in FIGS. 6 to 8, in which case the intermediate element 60 directly surrounds the inner forming element 54. In one embodiment not shown, other components can be interposed between the inner forming element 54 and the intermediate element 60, in which case the intermediate element 60 surrounds the inner forming element 54 with those components interposed.

The mould 51 further comprises a female forming element 58 suitable for shaping the object from the outside.

The inner forming element 54 and the female forming element 58 are aligned along a moulding axis Z1. In the example shown, the moulding axis Z1 is vertical, but this condition is not necessary and, in an embodiment not shown, the moulding axis Z1 could be horizontal or slanting.

The inner forming element 54 and the female forming element 58 are movable one relative to the other along the moulding axis Z1, owing to a movement device not shown, between a spaced apart configuration and a forming configuration. In the spaced apart configuration, which is not shown in the Figures, the inner forming element 54 and the female forming element 58 are spaced apart from each other, so that it is possible to remove from the mould 51 a formed object and to introduce into the mould 51 new mouldable material to be formed. In the forming configuration, shown in FIG. 8, between the inner forming element 54 and the female forming element 58 the mouldable material has been shaped, thereby obtaining the object.

In the example shown, the female forming element 58 is positioned above the inner forming element 54. This condition is not necessary and, in an embodiment not shown, the inner forming element 54 could be positioned below the female forming element 58.

The female forming element 58 can comprise a case 57, having for example a tubular shape, which extends around the moulding axis Z1. The case 57 at least partly surrounds the intermediate element 60. The case 57 can be in direct contact with the intermediate element 60, as shown in FIGS. 6 to 8, or—in an alternative embodiment not shown—one or more components can be interposed between the case 57 and the intermediate element 60. The intermediate element 60 extends around the moulding axis Z1.

The female forming element 58 further comprises a transversal forming surface 61 for shaping from the outside a transversal wall 64 of the object, that is to say, a wall of the object positioned transversally to the moulding axis Z1. The case 57 projects from the transversal forming surface 61 towards the inner forming element 54.

The transversal forming surface 61 can be made on a component separate from the case 57, said component in any event being fixed relative to the case 57. Alternatively, the transversal forming surface 61 and the case 57 can be included in a single mechanical part.

A hollow space 53 is defined between the inner forming element 54 and the case 57, the hollow space 53 extending around the moulding axis Z1. The hollow space 53 can be an annular space, for example having a cylindrical shape.

A forming chamber 52 is defined inside the mould 51, the forming chamber 52 being suitable for receiving the mouldable material. In the forming chamber 52, the mouldable material can be compressed to create the desired object. More specifically, the forming chamber 52 is defined inside the case 57. The forming chamber 52 is in particular defined between the female forming element 58, the inner forming element 54 and the intermediate element 60. The forming chamber 52 has a shape and dimensions which may vary depending on the step of the forming process in which the mould 51 is. The hollow space 53 is included in the forming chamber 52.

The intermediate element 60 is delimited, transversally to the moulding axis Z1, by an annular surface 62 facing the transversal forming surface 61. The annular surface 62 is suitable for forming an annular edge 66 of the object, shown in FIG. 8. The inner forming element 54 is delimited, transversally to the moulding axis Z1, by a front surface 63 facing the transversal forming surface 61.

A movement device not shown is also provided for moving the intermediate element 60 and the hollow space 53 one relative to the other. The movement device can for example be associated with the intermediate element 60. In this way the intermediate element 60 is movable inside the hollow space 53 with a linear movement parallel to the moulding axis Z1. That linear movement occurs alternately towards the transversal forming surface 61 and away from the transversal forming surface 61.

More specifically, the intermediate element 60 is positionable in the hollow space 53 in a back position P1, shown in FIG. 7, in which a considerable portion of the inner forming element 54 projects from the intermediate element 60 inside the forming chamber 52. In the back position P1 of the intermediate element 60, the volume of the hollow space 53 is at its maximum. Thus, the mouldable material can be received between the case 57 and the inner forming element 54.

The intermediate element 60 is shiftable relative to the inner forming element 54 from the back position P1 towards a forming position P2, shown in FIG. 8, in which the forming chamber 52 has the shape of the object to be obtained and the annular edge 66 of the object is formed in contact with the intermediate element 60. In the forming position P2, the inner forming element 54 projects from the intermediate element 60 less than it did in the back position P1. In order to pass from the back position P1 to the forming position P2, it is possible to move the intermediate element 60 in a direction parallel to the moulding axis Z1 towards the transversal forming surface 61. The intermediate element 60 is also positionable in other positions relative to inner forming element 54, in addition to the back position P1 and the forming position P2. For example, the intermediate element 60 can be positioned in any intermediate position between the back position P1 and the forming position P2, or even in a position in which the inner forming element 54 projects from the intermediate element 60 less than it does in the forming position P2.

The intermediate element 60 could be positioned in a forward position P0, shown in FIG. 6, in which the annular surface 62 is substantially aligned with the front surface 63, that is to say, the annular surface 62 and the front surface 63 are positioned substantially at the same level along the moulding axis Z1.

The hollow space 53 corresponds to a region of the forming chamber 52 intended to create the lateral wall 65 of the object. A portion of the forming chamber 52 located between the transversal forming surface 61 and the front surface 63 is in contrast intended to create the transversal wall 64. During operation, the inner forming element 54 and the female forming element 58 are initially in the spaced apart configuration not shown in the Figures, in which the forming chamber 52 is open and accessible from the outside, so that it is possible to remove from the mould 51 an object just formed. Subsequently, the inner forming element 54 and the female forming element 58 are brought one near the other and brought into the initial configuration shown in FIG. 6, in which the forming chamber 52 is closed and is filled with the mouldable material. The latter was introduced into the forming chamber 52 by a filling device not shown.

In the initial configuration shown in FIG. 6, the forming chamber 52 has a much greater volume than the volume of the object to be formed and a shape different from the shape of the object to be formed. In the example shown, in the initial configuration shown in FIG. 6, the annular surface 62 of the intermediate element 60 is substantially aligned, along the moulding axis Z1, with the front surface 63 of the inner forming element 54. Therefore, the forming chamber 52 has a substantially cylindrical shape. In this configuration, no hollow space 53 is defined between the inner forming element 54 and the intermediate element 60.

Subsequently, as shown in FIG. 7, the movement device, which in the example shown is associated with the intermediate element 60, moves the intermediate element 60 away from the transversal forming surface 61. The inner forming element 54, like the female forming element 58, remain in their previous position. The intermediate element 60 reaches the back position P1, in which the volume of the hollow space 53 is at its maximum. This creates a pulling force, that is to say, a sort of drawing in or suction which attracts into the hollow space 53 the mouldable material which was previously positioned between the transversal forming surface 61 and the front surface 63. This pulling force is similar to that which occurs in a syringe when the plunger is pulled back to suck in a liquid. Owing to the above-mentioned pulling force, the mouldable material can fill the hollow space 53 relatively easily, even if the hollow space 53 has a considerable dimension along the moulding axis Z1 or a limited radial thickness.

In other words, the backward movement of the intermediate element 60 (that is to say, the movement of the intermediate element 60 away from the transversal forming surface 61) generates a negative pressure in the hollow space 53 which allows the mouldable material to flow into the hollow space 53 and to fill the hollow space 53.

In the example shown, the mouldable material flows into the hollow space 53 aided by the force of gravity.

However, if the inner forming element 54 is not positioned below the female forming element 58, the mouldable material in any event fills the hollow space 53 due to the effect of the pulling force applied by the intermediate element 60 which moves along the moulding axis Z1 away from the transversal forming surface 61.

In the configuration of FIG. 7, the mouldable material which fills the forming chamber 52, including the hollow space 53, has a relatively low density, much lower than the density of the mouldable material in the object formed.

After having reached the configuration of FIG. 7, and therefore having filled the hollow space 53 with the mouldable material, the driving device moves the inner forming element 54 and the female forming element 58 one towards the other along the moulding axis Z1. The inner forming element 54 thereby penetrates inside the case 57 to form the transversal wall 64 of the object. Simultaneously, the movement device associated with the intermediate element 60 moves the latter parallel to the moulding axis Z1 towards the transversal forming surface 61, until reaching the forming position P2 shown in FIG. 8, in which the distance between the annular surface 62 and the transversal forming surface 63 is substantially equal to the height of the object to be obtained. The lateral wall 65 of the object is formed in this way.

The forming chamber 52 reaches its definitive shape and the mouldable material is compressed until it reaches the desired density and the object to be formed is obtained. The mould 51 is now ready to be returned to the spaced apart configuration and to begin a new forming cycle.

The mould 51 can have vent openings not shown to allow the air initially mixed with the mouldable material to come out of the forming chamber 52 while the object is formed.

The mould 51 shown in FIGS. 6 to 8 allows good quality concave objects to be obtained, in which the mouldable material has a substantially uniform degree of compaction, that is to say, a practically constant density. In terms of construction and operation the mould 51 is very simple, since it does not require radial movements of its components, but operates only by moving the elements of which it is composed in an axial direction, that is to say, parallel to the moulding axis Z1.

By moving the intermediate element 60 away from the transversal forming surface 61 after the forming chamber 52 has been filled and closed, a negative pressure is created in the hollow space 53 which allows the mouldable material to flow between the inner forming element 54 and the case 57, in order to create the lateral wall 65 of the object.

FIGS. 9 to 11 show a mould 151 according to an alternative embodiment, which differs from the mould 51 shown in FIGS. 6 to 8 mainly because it comprises a female forming element 158 having a structure different from the female forming element 58 of the mould 51.

The parts of the mould 151 common to the mould 51 will be indicated with the same reference numbers used in FIGS. 6 to 8 and will not be described again in detail.

More specifically, the female forming element 158 comprises a pusher component 67 facing the intermediate element 60 for pushing the mouldable material into the hollow space 53. The pusher component 67 extends around the moulding axis Z1 and can have a tubular shape.

The pusher component 67 is axially aligned with the intermediate element 60. In particular, the pusher component 67 can have an inner transversal dimension and an outer transversal dimension which are substantially equal to the corresponding transversal dimensions of the intermediate element 60, even if this condition is not necessary.

The female forming element 158 further comprises an inner core 68, delimited by a transversal forming surface 161 arranged transversally, in particular perpendicularly, to the moulding axis Z1. The transversal forming surface 161 is facing the front surface 63 of the inner forming element 54. The female forming element 158 further comprises a case 157, which can have a tubular shape and which extends around the moulding axis Z1. The case 157 is similar to the case 57 of the mould 51 shown in FIGS. 6 to 8. The pusher component 67 is interposed between the inner core 68 and the case 157.

A displacement device not shown is provided for moving the pusher component 67 relative to the inner core 68 and to the case 157, with a linear movement back and forth in a direction parallel to the moulding axis Z1. The pusher component 67 is therefore slidable between the inner core 68 and the case 157.

In particular, the displacement device is configured to move the pusher component 67 so that the latter substantially follows the intermediate element 60.

During operation, the mould 151 is brought into the initial configuration shown in FIG. 9, similar to the initial configuration of the mould 51 shown in FIG. 6. In the initial configuration, a forming chamber 52 is defined between the male mould element 54 and the female mould element 158, the forming chamber 52 being full of mouldable material and having a volume much greater than the object to be obtained, and a shape different from the latter. In the initial configuration shown in FIG. 9, an end surface 69 of the pusher component 67 is substantially aligned, along the moulding axis Z1, with the transversal forming surface 161, that is to say, the end surface 69 is substantially at the same level as the transversal forming surface 161. Similarly, the annular surface 62 of the intermediate element 60 is substantially aligned, along the moulding axis Z1, with the front surface 63 of the inner forming element 54. Therefore, the forming chamber 52 can be substantially cylindrical.

Subsequently, the intermediate element 60 is moved back relative to the inner forming element 54, that is to say, is moved away from the transversal forming surface 161, in such a way as to define the hollow space 53 between the inner forming element 54 and the case 157. The intermediate element 60 is brought into the back position P1, shown in FIG. 10, in which the volume of the hollow space 53 is at its maximum. The movement of the intermediate element 60 towards the back position P1 generates a negative pressure inside the hollow space 53, owing to which the mouldable material present in the forming chamber 52 is drawn into the hollow space 53. In order to promote the flow of the mouldable material into the hollow space 53, the latter can be connected to a suction source not shown which, as indicated by the arrows K, sucks the mouldable material into the hollow space 53.

While the intermediate element 60 is moved back, by moving it away from the transversal forming surface 161, the pusher component 67 is moved forward, thereby bringing it near the inner forming element 54. In one embodiment, the pusher component 67 can be moved forward by the same amount as the intermediate element 60 is moved back, in such a way that the pusher component 67 and the intermediate element 60 remain at a constant distance.

By moving the pusher component 67 towards the intermediate element 60, the pusher component 67 pushes the mouldable material interposed between the end surface 69 and the annular surface 62 towards the hollow space 53. The thrust applied by the pusher component 67 helps the mouldable material to fill the hollow space 53, even if the latter is long and/or narrow, or even if the mouldable material does not flow easily.

After the hollow space 63 has been filled, the inner forming element 54 is moved towards the inner core 68 to shape the transversal wall 64 of the object. The intermediate element 60 is also moved forward towards the transversal forming surface 161 and, simultaneously, the pusher component 67 is moved back towards the inner core 68, until the end surface 69 is brought into a position flush with the transversal forming surface 161. The end surface 69 and the transversal forming surface 161 thereby form an outer face of the transversal wall 64 of the object. In the hollow space 53, whose height has been reduced, the lateral wall 65 of the object is formed, whose annular edge 66 is shaped by the intermediate element 60.

FIGS. 12 to 14 show a mould 251 according to an alternative embodiment. The mould 251 is structurally similar to the mould 51 previously described, but operates differently from the latter.

The mould 251 comprises a female forming element 258 which includes a case 257, extending around the moulding axis Z1, inside which an inner core 268 is housed. The inner core 268 is slidable back and forth, in a direction parallel to the moulding axis Z1, inside the case 257. For that purpose, a displacement device not shown is associated with the inner core 268. The inner core 268 is delimited by a transversal forming surface 261, facing the inner forming element 54.

The remaining components of the mould 251, which are substantially the same as those of the mould 51, will be indicated with the same reference numbers used in FIGS. 6 to 8 and will not be described again in detail. During operation, as shown in FIG. 12, the mould 251 is brought into the initial configuration, which is substantially identical to the initial configuration of the mould 51 shown in FIG. 6. The annular surface 62 of the intermediate element 60 is flush with the front surface 63 of the inner forming element 54. The forming chamber 52 can have a cylindrical shape.

Subsequently, while the inner forming element 54 is kept in a fixed position, the intermediate element 60 is moved back, that is to say, moved away from the front surface 63, to create the hollow space 53. This generates, in the hollow space 53, a negative pressure which pulls the mouldable material into the hollow space 53.

The flow of the mouldable material into the hollow space 53 can be aided by a suction source not shown which, as indicated by the arrows K, sucks the mouldable material between the case 257 and the inner forming element 54.

Simultaneously, as shown in FIG. 13, the inner core 258 is brought near the inner forming element 54, consequently reducing the volume of the forming chamber 52. That has the dual effect of compressing the mouldable material present in the forming chamber 52, reducing its density, and of aiding the flow of the mouldable material towards the hollow space 53, which in this way can be filled more easily.

After the intermediate element 60 has reached the back position P1 shown in FIG. 13 and after the hollow space 53 has been filled with the mouldable material, the intermediate element 60 moves forward along a direction parallel to the moulding axis Z1, so as to compress the mouldable material present in the hollow space 53 and to reduce the axial dimensions of the hollow space 53.

Simultaneously, while the case 257 remains in a fixed position, the inner core 258 is moved back to return to the original position, in which it was located in the initial configuration shown in FIG. 12. The inner forming element 54 is shifted in a direction parallel to the axis Z1 towards the inner core 268. The inner forming element 54 in this way follows the inner core 258 and is positioned at a distance from the latter which is equal to the thickness of the transversal wall 64 of the object, as shown in FIG. 14.

The desired object is obtained in this way.

In all of the embodiments of the mould 51, 151, 251 previously described, there can be vent openings or holes in the forming chamber 52, in particular in the hollow space 53, for making the air mixed with the mouldable material come out gradually as the mouldable material is compressed.

In all of the embodiments of the mould 51, 151, 251 previously described the hollow space 53 can be connected to a suction source not shown to facilitate filling of the hollow space 53 by the mouldable material. FIGS. 15 and 16 show a mould 351 for forming a concave object, that is to say, an object having a lateral wall which extends around an axis and a transversal wall which extends transversally to the axis. The examples of concave objects which can be formed in the mould 351 include caps, containers, preforms for containers. The object is formed in the mould 351 by compressing a mouldable material which can comprise a material derived from natural fibres and can be fed into the mould 351 in the form of granules, flakes or powder.

The mould 351 comprises a forming chamber 352 suitable for receiving the mouldable material which must be pressed to obtain the object. As shown in FIG. 16, the forming chamber 352 comprises a lateral portion 353, which extends around an axis Z2 and is intended to create the lateral wall of the object. The lateral portion 353 can be a tubular portion. The forming chamber 352 can further comprise a transversal portion 356, in which the transversal wall of the object can be formed.

The mould 351 comprises an inner forming element 354, suitable for shaping an inner surface of the object. The inner forming element 354 can be a male forming element.

The inner forming element 354 has a transversal surface 363 arranged transversally to the axis Z2 to delimit the transversal portion 356. The inner forming element 354 is housed in a case 357, which can have a tubular shape and extend around the axis Z2. The lateral portion 353 of the forming chamber 352 is identified between the case 357 and the inner forming element 354.

The mould 351 further comprises a filling device 301 for filling the forming chamber 352 with the mouldable material.

In the example shown, the filling device 301 is positioned above the inner forming element 354, which facilitates filling of the forming chamber 352 because it allows the force of gravity to be exploited for introducing the mouldable material into the forming chamber 352. The mould 351 is configured to form the object in an upside down configuration, that is to say, with the concavity facing downwards. However, this condition is not necessary. In one embodiment not shown, the filling device could be positioned below the forming cavity 352, in which case the forming chamber 352 could be filled with the aid of suction and/or of pressurised air. The filling device 301 comprises a containment body 364 which can be positioned in contact with the case 357.

The filling device 301 has a first duct or central duct 365 for feeding the mouldable material into the transversal portion 356 of the forming chamber 352. The central duct 365 can extend along the axis Z2.

More specifically, the filling device comprises an intermediate body 367 inside which the central duct 365 is made. The intermediate body 367 can have a main dimension, that is to say, a length, which extends along the axis Z2, The intermediate body 367 can have a tubular shape and can for example have a lateral wall which extends around the axis Z2.

Movable inside the central duct 365 is a closing member 366, in particular shaped like a rod, which extends along the axis Z2 and is coaxial with the central duct 365. The central duct 365 has a transit cross-section for the mouldable material shaped like an annulus, because a central part of the central duct 365 is occupied by the closing member 366.

The closing member 366 is linearly shiftable back and forth along the axis Z2 to put the central duct 365 in communication with the transversal portion 356 of the forming chamber 352 or alternatively to isolate the central duct 365 from the transversal portion 356.

In particular, the closing member 366 is movable between a closed position, shown in FIG. 15, in which the mouldable material cannot come out of the central duct 365, and an open position, shown in FIG. 16, in which the mouldable material can flow from the central duct 365 towards the forming cavity 352, in particular towards the transversal portion 356 of the forming cavity. The closing member 366 is shiftable between the closed position and the open position owing to a driving element that is not shown.

In the closed position, one end 369 of the closing member 366 engages with an inner sealing surface 368 of the intermediate body 367, that is to say, is in contact with the inner sealing surface 368. The end 369 can optionally be a tapered end of the closing member 366, for example a bevelled or rounded end. In the open position, the end 369 is spaced apart from the inner sealing surface 368, so as to allow the mouldable material to pass from the central duct 365 towards the transversal portion 356, particularly through an annular passage defined between the end 369 and the inner sealing surface 368. The end 369 is delimited, transversally to the axis Z2, by a front surface 375 which can be flat. The front surface 375 is facing the inner forming element 354.

The central duct 365 is configured to receive coming in a central flow or first flow H1 of mouldable material and air, particularly compressed air. The first flow H1 enters the central duct 365 through a further end of the central duct 365 opposite to the end 369, that is to say—in the example shown—through an upper end.

The mould further comprises a second duct or peripheral duct 370 for feeding the mouldable material into the lateral portion 353 of the forming chamber 352. In the example shown, the peripheral duct 370 has an annular shape and is defined in a hollow space between the containment body 364 and the intermediate body 367. The peripheral duct extends around the axis Z2. An entry duct 310, which extends transversally to the axis Z2, opens into the peripheral duct 370, for example in a region of the peripheral duct 370 further from the forming chamber 352. The entry duct 310 is intended to send into the peripheral duct 370 a secondo flow or peripheral flow H2 of mouldable material and air, for example mouldable material and compressed air.

The peripheral duct 370 can be selectively put in communication with the lateral portion 353 of the forming chamber 352 or isolated from the lateral portion 353 owing to a shutter 371. In the example shown, the shutter 371 is made on a widened end portion of the intermediate component 367. The widened end portion is delimited by an outer sealing surface 372, which extends around the axis Z2 and can have a frustoconical shape. The outer sealing surface 372 is suitable for engaging in a shapingly coupled manner with an abutting surface 373 which can be made on the containment body 364. The abutting surface 373 can have the shape of a frustoconical bevel, formed in the containment body 364, at which an outer diameter of the peripheral duct 370 increases, if shifting from the filling device 301 towards the forming chamber 352.

The outer sealing surface 372 and the inner sealing surface 368 are made at the same height of the intermediate body 367, respectively on a lateral surface of the intermediate body 367, facing the containment body 364, and on a further lateral surface of the intermediate body 367, directed towards the axis Z2.

The intermediate body 367 further has a front sealing surface 374 which can be positioned transversally, in particular perpendicularly, to the axis Z2. The front sealing surface 374 is facing the male forming element 35. The front sealing surface 374 can be substantially flat and can optionally be shaped like an annulus. The front sealing surface 374 is suitable for abutting against the inner forming element 354 for isolating the central duct 365 from the lateral portion 353 of the forming chamber 352.

Movement means are associated with the intermediate body 367 for moving the intermediate body 367 back and forth parallel to the axis Z2, with a linear movement.

More specifically, the intermediate body 367 is movable between a forward position, shown in FIG. 15, and a back position, shown in FIG. 16. In the forward position, the front sealing surface 374 is in contact with the transversal surface 363 of the inner forming element 354, whilst the outer sealing surface 372 is spaced apart from the abutting surface 373 of the containment body 364. In this way the peripheral duct 370 is open and communicating with the lateral portion 353 of the forming chamber 352. In the back position, the front sealing surface 374 is spaced apart from the inner forming element 354, whilst the outer sealing surface 372 is spaced apart from the containment body 364. In this way the peripheral duct 370 is closed.

The mould 351 further comprises an intermediate forming element not shown, which can be shaped like an annular forming element, for closing the lateral portion 353 of the forming chamber 352 on the opposite side to the filling device 301, that is to say, on the lower side in FIGS. 15 and 16. The intermediate forming element can also be movable in the lateral portion 353 for compacting the mouldable material.

During operation, in order to fill the mould 351, the movement means acting on the intermediate body 367 shift the latter into the forward position shown in FIG. 15, in which the front sealing surface 374 is in contact against the inner forming element 354, in particular against the transversal surface 363. Simultaneously, the driving element acting on the closing member 366 shifts the latter into the closed position in which the end 369 engages with the inner sealing surface 368 of the intermediate body 367. In the closed position, the end 369 is furthermore in contact with the transversal surface 363 of the inner forming element 354. In this way the central duct 365 is closed.

Since, in the forward position, the outer sealing surface 372 of the intermediate body 367 is detached from the containment body 364, the peripheral duct 370 is open. The flow H2 of mouldable material and air is sent into the peripheral duct 370 and from the latter passes into the lateral portion 353 of the forming chamber 352. In this way the lateral portion 353 is filled. Associated with the lateral portion 353 there is a plurality of vent holes not shown, which are made for example in the case 357, through which the excess air originally mixed with the mouldable material can come out of the forming chamber 352, in particular from the annular portion 353, as indicated by the arrows K.

It should be noticed that, when the intermediate body 367 is in the forward position and the closing member 366 is in the closed position, that is to say, when the condition shown in FIG. 15 occurs, the transversal portion 356 of the forming chamber 352 is not yet defined, that is to say, it has a volume which is practically zero. Indeed, the closing member 366 and the intermediate body 367 are both in contact with the transversal surface 363 of the inner forming element 354, and the mouldable material cannot reach the transversal surface 363.

It should also be noticed that, in the forward position of the intermediate body 364, shown in FIG. 15, the outer sealing surface 372, which is flared outwards, acts as a chute to facilitate the flow of the mouldable material from the peripheral duct 370 towards the lateral portion 353 of the forming chamber 352. That is particularly useful if, as in the example shown, the average diameter of the peripheral duct 370 is less than the average diameter of the annular portion 353.

The maximum outer diameter of the shutter 371 can be substantially equal to the diameter of the transversal surface 363 with which the shutter 371 is in contact in the forward position. This prevents the presence of steps which could obstruct the flow of mouldable material between the shutter 371 and the inner forming element 354.

Moreover, the geometry of the abutting surface 373, which can be shaped like a bevel, makes it possible to avoid sharp edges which could make it less easy for the mouldable material to pass from the peripheral duct 370 to the lateral portion 353.

The intermediate body 364 and the closing member 366 remain in the position shown in FIG. 15 until the lateral portion 353 of the forming chamber 352 has been filled. At this point, the intermediate body 364, on which the shutter 371 is made, is moved back, that is to say, moved along the axis Z2 away from the inner forming element 354, until it reaches the back position shown in FIG. 16. In this way the outer sealing surface 372 makes contact with the abutting surface 373 of the containment body 364, consequently closing the peripheral duct 370, which is no longer in communication with the forming chamber 352.

Also the closing member 366 is moved back, that is to say, moved parallel to the axis Z2 away from the inner forming element 354. The closing member 366 is moved back by an amount greater than the amount by which the intermediate body 364 is moved back, in such a way that it detaches from the inner sealing surface 368 and moves into the open position. The central duct 365 is thus opened, the central duct 365 opening into a central region of the transversal portion 356 of the forming chamber 352.

The transversal portion 356 is in communication with the lateral portion 353, which has already been substantially filled.

When the intermediate body 367 moves into the back position, in addition to closing the peripheral duct 370, the transversal portion 356 of the forming chamber 352 is defined. That happens because, when the shutter 371 and the closing member 366 move away from the inner forming element 354, an empty space is created in a position adjacent to the transversal surface 363, which corresponds to the transversal portion 356 of the forming chamber 352.

The flow H1 of mouldable material and air is now fed into the central duct 365, and from here passes into the transversal portion 356 of the forming chamber 352. In this way the transversal portion 356 of the forming chamber 352 is also filled. The transversal portion 356 has one or more vent holes not shown, for example made in the case 357. Through the vent holes, the excess air initially mixed with the mouldable material can be discharged from the forming chamber 352, as indicated by the arrows J.

The closing member 366 is now brought into the closed position, by moving it towards the inner forming element 354, whilst the intermediate body 364 remains in the back position. In this configuration, the front sealing surface 374 of the shutter 371 and the front surface 375 of the closing member 366 define a surface of the transversal portion 356 opposite to the transversal surface 363 of the inner forming element 354. The front sealing surface 374 and the front surface 375 can, optionally, lie in the same plane when the closing member 366 is located in the closed position and the intermediate body 364 is located in the back position.

It is now possible to move the inner forming element 354 and the case 357 relative to each other to reduce the volume of the forming chamber 352 and to obtain the desired object.

FIGS. 17 to 20 show a mould 451 which has many similarities to the mould 351 shown in FIGS. 15 and 16. The parts of the mould 451 common to similar parts of the mould 351 will be indicated with a reference number in which the first digit is a “4” rather than a “3” and in which the final two digits coincide with the final two digits used for the same mould part in FIGS. 15 and 16, without being described again in detail. It shall be understood that what was previously described with reference to FIGS. 15 and 16 also applies to FIGS. 17 to 21, unless otherwise explicitly specified. The mould 451 comprises a first mould part 421 and a second mould part 422, aligned with each other along the axis Z2. As shown in FIG. 17, the first mould part 421 comprises the inner forming element (or male forming element) 454, the case 457 and an intermediate forming element 460, interposed between the inner forming element 454 and the case 457, for forming an edge region of the object. The intermediate forming element 460 can be an annular forming element, for example arranged to form an annular edge region of the object.

The second mould part 422 comprises the filling device 401, which in the example shown is housed in a housing member 423 having a shoulder 424 delimited, transversally to the axis Z2, by a stop surface 425. The latter is intended to make contact against an abutting end 426 of the first mould part 421, the abutting end 426 being for example made on the case 457. The housing member 423 comprises a projecting part 427 which projects from the stop surface 425 towards the first mould part 421. The projecting part 427 can be suitable for engaging by means of shape coupling with the case 457. For that purpose, the projecting part 427 can have an outer diameter equal to an inner diameter of the case 457.

The containment body 464 and the intermediate body 467 are positioned inside the housing member 423, the shutter 471 being made on the intermediate body 467. The closing member 466, the containment body 464 and the intermediate body 467 are included in the filling device 401 which is linearly movable back and forth relative to the housing member 423, in a direction parallel to the axis Z2, to penetrate inside the case 457 or alternatively to withdraw from the case 457.

During operation, the mould 451 is initially in a spaced apart configuration shown in FIG. 17, in which the first mould part 421 and the second mould part 422 are separate from each other, so that it is possible to remove from the mould an object just formed. In the spaced apart configuration, the stop surface 425 is far from the abutting end 424.

Subsequently, the first mould part 421 and the second mould part 422 are mutually moved one towards the other, until they reach a closed mould configuration shown in FIG. 18, in which the stop surface 424 of the housing member 423 abuts against the abutting end 425 of the case 457. The projecting part 427 is now received inside the case 457.

In the example shown, the closed mould configuration is reached by moving the second mould part 422 towards the first mould part 421, which remains fixed along the axis Z2, but this condition is not necessary.

The filling device 401 is now shifted towards the inner forming element 454. In this way, the filling device 401 comes out of the housing member 423. More specifically, as shown in FIG. 18, the closing member 466 and the shutter 471 made on the intermediate body 467 are brought into contact with the transversal surface 463 of the inner forming element 454. The closing member 466 is in the closed position, in which the central duct 465 is isolated from the forming chamber 452.

The containment body 464, although remaining in a back position relative to the intermediate body 467, nevertheless projects from the projecting part 427 of the housing member 423 so as to move towards the inner forming element 454.

In more detail, the containment body 464 is positioned in such a way that the abutting surface 473 is spaced apart from the shutter 471. In this way the peripheral duct 470 is open and the flow H2 of mouldable material and air can enter the forming chamber 452.

Unlike what happened in the embodiment described with reference to FIGS. 15 and 16, in which the peripheral duct 470 was configured to feed the mouldable material only into a tubular portion of the forming chamber positioned below the filling device, in the embodiment of FIGS. 17 to 20 the peripheral duct 470 allows the mouldable material to be fed into the forming chamber 452 according to a different arrangement.

More specifically, as shown in FIG. 18, when the shutter 471 is in contact with the inner forming element 454, the forming chamber 452 has, in addition to the lateral portion 453 which surrounds the inner forming element 454, a tubular appendage 428 which surrounds the filling device 401. The tubular appendage 428 is interposed between the case 457 and the containment body 464. The tubular appendage 428 and the lateral portion 453 are positioned on two opposite sides of the zone in which the peripheral duct 470 opens into the forming chamber 452.

The lateral portion 453 can be tubular.

When the flow H2 of mouldable material arrives in the forming chamber 452, that flow is divided into two secondary flows, that is to say, an ascending flow H21 and a descending flow H22. In the example shown, the ascending flow H21 flows upwards into the tubular appendage 428, whilst the descending flow H22 flows downwards into the lateral portion 453 of the forming chamber 452.

The peripheral duct 470 opens into the forming chamber 452 in a zone positioned roughly centrally along the axis Z1, that is to say, in a roughly central zone along the height of the forming chamber 452. That allows faster filling of the forming chamber 452 than if the forming chamber were filled by making the mouldable material flow axially from one end to the other of the forming chamber. That is particularly evident if the forming chamber 452 has a considerable height, that is to say, a significant dimension along the axis Z2.

The mouldable material continues to flow along the peripheral duct 470 until both the lateral portion 453 and the appendage 428 of the forming chamber 452 have been filled. During filling, the excess air mixed with the mouldable material can come out of the forming chamber through suitable vent passages. A vent passage can for example be defined in an interface between the intermediate forming element 460 and the case 457, for making the air come out of the lateral portion 453 of the forming chamber 452, as indicated by the arrows A1. A further vent passage can be defined between the stop surface 425 and the abutting end 426, so that the air can flow out of the tubular appendage 428 of the forming chamber 452, as shown by the arrows A2 in FIG. 18.

When the lateral portion 453 and the tubular appendage 428 have been filled with the mouldable material, the shutter 470 is shifted into the back position, bringing it into contact with the containment body 464 so as to close the peripheral duct 470. The entire filling device 401 is moved away from the inner forming element 454. As shown in FIG. 19, the filling device 401 is in particular positioned in such a way that the front sealing surface 474 of the shutter 471 is coplanar with an end of the containment body 464 and with a further end of the projecting part 427, the above-mentioned end and further end facing the inner forming element 454.

That allows the shape of the forming chamber 452 to be changed, considerably increasing its volume. In particular the transversal portion 456 of the forming chamber 452 is defined, the transversal portion 456 extending between the filling device 401 and the transversal surface 463 of the inner forming element 454. The transversal portion 456 occupies the entire space defined inside the tubular appendage 428, optionally for the entire height of the tubular appendage 428. Therefore the tubular appendage 428 is no longer distinguishable in the forming chamber 452.

The closing member 466 is brought into the open position shown in FIG. 19, by moving it parallel to the axis Z2 away from the inner forming element 454. In this way the closing member 466 moves away from the intermediate body 467, in particular from the shutter 471, and the central duct 465 is put in communication with the forming cavity 452, as shown in FIG. 19. The flow of mouldable material and air which enters the central duct 465, as indicated by the arrows H1, can therefore fill the forming chamber 452. In this step too, the excess air mixed with the mouldable material can come out through suitable vent passages, as indicated by the arrows A1 and A2 in FIG. 19 and as previously described with reference to FIG. 18.

At the end of the step previously described, both the lateral portion 453 and the transversal portion 456 of the forming chamber 452 have been filled with the mouldable material. At this point, the closing member 466 is brought into the closed position, so as to close the central duct 465.

As shown in FIG. 20, the first mould part 421 and the second mould part 422 are moved towards one another to reduce the volume of the forming chamber 452, to compress the mouldable material and to obtain the desired object. More specifically, the mouldable material contained in the transversal portion 456 is compressed to create a transversal wall 429 of the object, whilst the mouldable material contained in the annular portion 453 is compressed to form a lateral wall 430 of the object.

In the example shown, the mouldable material is compressed by moving the second mould part 422 towards the first mould part 421 in a moulding direction parallel to the axis Z2. More specifically, the second mould part 422 is moved downwards, as shown in FIG. 20.

The front surface 475 of the closing element 466, the front sealing surface 474 of the shutter 471, the end of the containment body 464 and the further end of the projecting part 427 are aligned, for example they lie in a common plane, to define an outer surface of the transversal wall 429 of the object. In the example shown, the case 457 and the inner forming element 454 are also moved parallel to the axis Z2 to compress the mouldable material. In particular, the case 457 and the inner forming element 454 are moved in a direction which is the same as the movement of the second mould part 422, that is to say, downwards in FIG. 20.

That is to say, the case 457 and the inner forming element 454 are moved towards the intermediate forming element 460, which remains in a fixed position along the axis Z2.

In other words, as shown in FIG. 20, the position of an annular forming surface 431 which delimits the intermediate forming element 460 is kept fixed along the axis Z2. The object is formed by moving both the transversal surface 463 of the inner forming element 454, and the second mould part 422 towards the annular forming surface 431. In this way the mouldable material is compressed both in the lateral portion 453, which creates the lateral wall 430 of the object, and in the transversal portion 456, which creates the transversal wall 429 of the object.

While the mouldable material is compressed, the air contained in the mouldable material continues to be expelled from the mould 451 through the vent passages previously described, as indicated by the arrows A1 and A2.

In this way an object is formed which has a uniform degree of compaction, in a mould having a relatively simple geometry, whose parts are only driven with axial movements. That is to say, radial movements which would make both the design and operation of the mould more complicated are avoided. In all of the embodiments described up to now, the vent holes or openings or passages can be associated with suction means to facilitate the flow of the mouldable material.

Although up to now reference has only been made to mouldable material in dry form, for example in the form of powder, granules or flakes, all of the embodiments previously described can also operate with a mouldable material in a pasty form, particularly a mouldable material in which a liquid is present, for example a binding agent or water. Again in this case, it is possible to feed into the mould a flow of air and mouldable material, that is to say, to use the air to convey the mouldable material.

In all of the embodiments previously described with reference to FIGS. 1 to 20, the object which is formed, rather than having a concave shape as in the case of a container, a cap or a preform for a container, can have a substantially tubular shape open at both ends, that is to say, can have a lateral wall which, during moulding, extends around the axis of the mould, whilst the transversal wall positioned transversally to the axis can be absent. The lateral wall can extend around an axis for 360°, that is to say, have a tubular shape which is closed around the axis, or can extend around the axis for less than 360°. In the latter case, the lateral wall can, for example, have a cross-section in the shape of a “C” or a “U”.

The lateral wall can have, in cross-section, any shape as required. In particular, the lateral wall can have, in cross-section, a shape not necessarily like an annulus, but also a shape which is elliptical, prismatic, oval or other.

To sum up, in the third aspect of the invention, a mould is provided for forming an object with a mouldable material, comprising a case (57; 157; 257), an inner forming element (54) at least partly housed in the case (57; 157; 257), an intermediate element (60) which surrounds the inner forming element (54), wherein between the inner forming element (54) and the case (57; 157; 257) a hollow space (53) can be defined, the intermediate element (60) being positionable in the hollow space (53) in a back position (P1), in which the mouldable material is received in the hollow space (53), the intermediate element (60) being slidable relative to the inner forming element (54) from the back position (P1) towards a forming position (P2), so as to reduce the volume of the hollow space (53) and to form a lateral wall (65) of the object.

In one embodiment, the case (57; 157; 257) is included in a female forming element (58; 158; 258), the female forming element (58; 158; 258) and the inner forming element (54) being movable one relative to the other along a moulding axis (Z1) to compress the mouldable material and to form the object.

In one embodiment, the female forming element (58) comprises a transversal forming surface (61) which extends transversally to the moulding axis (Z1) to shape a transversal wall (64) of the object, the case (57) projecting from the transversal forming surface (61) and being fixed relative to the transversal forming surface (61).

In one embodiment, the female forming element (158) comprises an inner core (68) delimited by a transversal forming surface (161) which extends transversally to the moulding axis (Z1) to shape a transversal wall (64) of the object, the female forming element (158) also comprising a pusher component (67) interposed between the inner core (68) and the case (157), the pusher component (67) being shiftable into a position projecting from the transversal forming surface (161) for pushing the mouldable material into the hollow space (53).

In one embodiment, the pusher component (67) is shiftable into the projecting position by a displacement device configured to move the pusher component (67) in such a way that the pusher component (67) follows the intermediate element (60).

In one embodiment, the female forming element (258) comprises an inner core (268) delimited by a transversal forming surface (261) which extends transversally to the moulding axis (Z1) to shape a transversal wall (64) of the object, the inner core (268) being shiftable in a direction parallel to the moulding axis (Z1) inside the case (257), so as to approach the inner forming element (54) and to push the mouldable material into the hollow space (53) before the intermediate element (60) reaches the forming position (P2).

In one embodiment, the mould further comprises a suction source connectable to the hollow space (53) for sucking the mouldable material into the hollow space (53).

In one embodiment, the hollow space (53) is shaped like an annular space and the intermediate element (60) is a tubular element.

In the fourth aspect of the invention, a method is provided for forming an object with a mouldable material, comprising the steps of:
introducing the mouldable material into a case (57; 157; 257), an inner forming element (54) being at least partly housed in the case (57; 157; 257), the inner forming element (54) being surrounded by an intermediate element (60);
moving the intermediate element (60) back relative to the inner forming element (54), thereby causing the mouldable material to flow into a hollow space (53) defined between the inner forming element (54) and the case (57; 157; 257);
moving the intermediate element (60) forward relative to the inner forming element (54), to reduce the volume of the hollow space (53) and to form a lateral wall (65) of the object.

In one embodiment, the step of moving the intermediate element (60) back comprises generating a negative pressure in the hollow space (53) which attracts the mouldable material into the hollow space (53).

In one embodiment, the case (57; 157; 257) is included in a female forming element (58; 158; 258), and furthermore the inner forming element (54) and the female forming element (58; 158, 258) are moved one towards the other along a moulding axis (Z1) to compress the mouldable material and to form a transversal wall (64) of the object, the transversal wall (64) extending transversally to the moulding axis (Z1).

In one embodiment, the method further comprises the step of applying a mechanical thrust to make the mouldable material flow into the hollow space (53).

In one embodiment, the mechanical thrust is applied by moving towards the hollow space (53) a pusher component (67) included in the female forming element (158) while the intermediate element (60) is moving back, the pusher component (67) being interposed between an inner core (68) of the female forming element (158) and the case (157).

In one embodiment, the mechanical thrust is applied by moving towards the inner forming element (54) an inner core (268) included in the female forming element (258) while the intermediate element (60) is moving back, the inner core (268) being surrounded by the case (257).

In one embodiment, the method further comprises the step of sucking the mouldable material into the hollow space (53) by means of a suction source while the intermediate element (60) is moving back.

In the fifth aspect of the invention, a mould is provided for forming an object with a mouldable material, comprising a forming chamber (352; 452) having a lateral portion (353; 453) which at least partly surrounds an axis (Z2), the mould (351; 451) further comprising a filling device (301; 401) having a peripheral duct (370; 470) which is selectively openable for feeding the mouldable material into the lateral portion (353; 453).

In one embodiment, the forming chamber (352; 452) further has a transversal portion (356; 456) which closes the lateral portion (353; 453) transversally to the axis (Z2), the filling device (301; 401) comprising a central duct (365; 465) which is selectively openable for feeding the mouldable material into the transversal portion (356; 456).

In one embodiment, the central duct (365; 465) extends along the axis (Z2) and the peripheral duct (370; 470) at least partly surrounds the central duct (365; 465), the peripheral duct (370; 470) optionally having an annular shape.

In one embodiment, the mould further comprises an inner forming element (354; 454) delimited by a transversal surface (363; 463) which extends transversally to the axis (Z2), the lateral portion (353; 453) surrounding the inner forming element (354; 454), and wherein the filling device (401; 501) is facing the transversal surface (363; 463).

In one embodiment, the inner forming element (354; 454) is positioned below the filling device (301; 401).

In one embodiment, the filling device (401; 501) comprises a closing member (366; 466) movable inside the central duct (365; 465) to open or alternatively to close the central duct (365; 465), the filling device (401; 501) further comprising a shutter (370; 470) movable relative to the peripheral duct (371; 471) to open or alternatively to close the peripheral duct (371; 471).

In one embodiment, the closing member (366; 466) and the shutter (370; 470) are positionable in contact with the transversal surface (356; 456) of the inner forming element (354; 454) to introduce the mouldable material into the lateral portion (353; 453), the closing member (366; 466) and the shutter (370; 470) further being movable away from the inner forming element (354; 454) to define the transversal portion (356; 456) of the forming chamber (352; 452) between the inner forming element (354; 454) and the filling device (301; 401).

In one embodiment, the filling device (301; 401) comprises an intermediate body (367; 467) inside which the central duct (365; 465) is made, the filling device (301; 401) further comprising a containment body (364; 464) which surrounds the intermediate body (367; 467), the shutter (370; 470) being made in an end portion of the intermediate body (367; 467).

In one embodiment, the end portion of the intermediate body (367; 467) is delimited by an inner sealing surface (368) directed towards the axis (Z2) and engageable with the closing member (366; 466) to close the central duct (365; 465), the end portion of the intermediate body (367; 467) further being delimited by an outer sealing surface (372) engageable with an abutting surface (373) which delimits the containment body (364; 464), so as to close the peripheral duct (371; 471).

In one embodiment, the end portion of the intermediate body (367; 467) is further delimited by a front surface (374) intended to abut against the transversal surface (363; 463) of the inner forming element (354; 454) while the lateral portion (352; 452) is filled.

In one embodiment, the inner sealing surface (368) converges towards the axis (Z2) to convey the mouldable material from the central duct (365; 465) towards a central zone of the transversal portion (363; 463), the outer sealing surface (369) diverging from the asse (Z2) to convey the mouldable material from the peripheral duct (370; 470) towards the lateral portion (353; 453)

In one embodiment, the forming chamber (352; 452) further comprises a tubular appendage (428) which surrounds the filling device (301; 401) and is adjacent to the lateral portion (363; 463).

In the sixth aspect of the invention, a method is provided for forming an object with a mouldable material in a forming chamber (352; 452) having a lateral portion (353; 453) which at least partly surrounds an axis (Z2), the method comprising the step of feeding the mouldable material into the lateral portion (353; 453) through a peripheral duct (370; 470).

In one embodiment, the forming chamber (352; 452) has a transversal portion (356; 456) which closes the lateral portion (353; 453) transversally to the axis (Z2), the method further comprising the step of feeding the mouldable material into the transversal portion (356; 456) through a central duct (365; 465).

In one embodiment, the step of feeding the mouldable material into the transversal portion (356; 456) occurs after the step of feeding the mouldable material into the lateral portion (353; 453).

In one embodiment, the lateral portion (353; 453) is positioned around an inner forming element (354; 454) included in the mould (351; 451).

In one embodiment, the central duct (365; 465) is openable or closable by a closing member (366; 466) and the peripheral duct (370; 470) is openable or closable by a shutter (371; 471).

In one embodiment, the mouldable material is fed into the lateral portion (353; 453) while the closing member (366; 466) and the shutter (371; 471) are in contact with the inner forming element (354; 454) and then the inner forming element (354; 454) and the assembly comprising the closing member (366; 466) and the shutter (371; 471) are moved away from each other, so as to define the transversal portion (365; 465) between the inner forming element (354); 454) and the assembly comprising the closing member (366; 466) and the shutter (371; 471).

In one embodiment, the method further comprises the step of compressing the mouldable material in the forming chamber (352; 452) to form the object, the step of compressing comprising the step of reducing a longitudinal dimension of the lateral portion (353; 453) along the axis (Z2) and the step of reducing a thickness of the transversal portion (356; 456) along the axis (Z2).

In one embodiment, the step of reducing the thickness of the transversal portion (356; 456) comprises moving one towards the other the inner forming element (354; 454) and a mould part (422) in which the closing member (366; 466) and the shutter (371; 471) are included, the step of reducing a longitudinal dimension of the lateral portion (353; 453) comprising moving one towards the other the inner forming element (354; 454) and an intermediate forming element (460) surrounding the inner forming element (354; 454) to shape an edge region of the object. In one embodiment, when a flow (H2) of mouldable material and air which flows in the peripheral duct (370; 470) arrives in the forming chamber (352; 452), the flow (H2) is divided into two secondary flows (H22, H21) which flow in opposite directions to fill the lateral portion (353; 453) and respectively a tubular appendage (428) adjacent to the lateral portion (353; 453), the tubular appendage (428) being opposite the lateral portion (353; 453) relative to the inner forming element (354; 454).

1. An apparatus comprising a mould part having a forming chamber and a filling device for filling the forming chamber with a mouldable material, the filling device comprising an entry duct for a flow of mouldable material and air and a preliminary chamber communicating with the forming chamber, wherein the entry duct opens into the preliminary chamber in a position such as to send the flow of mouldable material and air towards the forming chamber with a helicoidal movement, so as to separate the mouldable material from the air.

2. The apparatus according to claim 1, wherein the filling device is a cyclone separator for separating the mouldable material contained in the flow from the air, the preliminary chamber being arranged in a position adjacent to the forming chamber, so that the mouldable material separated from the air accumulates in the forming chamber.

3. The apparatus according to claim 1, wherein the filling device is positioned above the forming chamber.

4. The apparatus according to claim 1, wherein, in a filling position, the mould part and the filling device are aligned along an axis.

5. The apparatus according to claim 4, wherein the entry duct opens into the preliminary chamber in a direction which is not radial relative to the axis.

6. The apparatus according to claim 1, wherein the mould part comprises an inner forming element and an outer forming component which surrounds the inner forming element and is spaced apart from the inner forming element, a lateral portion of the forming chamber being defined between the outer forming component and the inner forming element.

7. The apparatus according to claim 6, wherein the lateral portion is aligned with a peripheral region of the preliminary chamber in which the flow of mouldable material and air is intended to move with said helicoidal movement.

8. The apparatus according to claim 6, wherein the forming chamber further comprises an end portion interposed between the inner forming element and the preliminary chamber.

9. The apparatus according to claim 8, wherein the filling device further comprises at least one distribution plate located in the preliminary chamber and delimiting the end portion of the forming chamber on the opposite side to the inner forming element.

10. The apparatus according to claim 1, wherein the filling device comprises an outfeed duct for allowing the air separated from the mouldable material to flow out of the preliminary chamber.

11. A method for filling a forming chamber of a mould with a mouldable material, comprising the step of sending a flow of mouldable material and air into a preliminary chamber communicating with the forming chamber, wherein the flow of mouldable material and air moves in the preliminary chamber with a helicoidal movement to separate the mouldable material from the air, and wherein the mouldable material separated from the air accumulates in the forming chamber.

12. The method according to claim 11, wherein the mouldable material accumulates at least in a lateral portion of the forming chamber, the lateral portion being aligned with a peripheral region of the preliminary chamber in which the helicoidal movement of the flow of mouldable material and air occurs.

13. The method according to claim 12, wherein the helicoidal movement of the flow of mouldable material and air continues in the lateral portion.

14. The method according to claim 12, wherein the mouldable material furthermore accumulates in an end portion of the forming chamber, the end portion extending transversally to the lateral portion in a position adjacent to the preliminary chamber.

15. The method according to claim 11, wherein a flow of air separated from the mouldable material flows out of the preliminary chamber with a helicoidal movement along a helix having an average radius smaller than the average radius of a further helix along which the helicoidal movement of the flow of mouldable material and air occurs.

16. The apparatus according to claim 5, wherein the entry duct opens into the preliminary chamber in a tangential direction.

17. The apparatus according to claim 6, the lateral portion has a tubular shape.

18. The apparatus according to claim 10, wherein the outfeed duct is provided in a region of the preliminary chamber opposite to the forming chamber.

19. The method according to claim 12, wherein the lateral portion has a tubular shape.
